(19) United States
(12) Patent Application Publication
(10) Pub. No.: US 2023/0127539 A1
(43) Pub. Date: Apr. 27, 2023

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: HARUKA FUJISAWA, TOKYO (JP); SHUNITSU KOHARA, TOKYO (JP); HAJIME WAKABAYASHI, TOKYO (JP); MAKOTO DANIEL TOKUNAGA, TOKYO (JP)

(21) Appl. No.: 17/918,009

(22) PCT Filed: Mar. 29, 2021
(86) PCT No.: PCT/JP2021/013170

§ 371 Date: Oct. 10, 2022

(30) Foreign Application Priority Data
Apr. 21, 2020 (JP) 2020-075734

(51) Int. Cl. G06T 19/00; G06T 19/20; G02B 27/01

(52) U.S. Cl. CPC G06T 19/006; G06T 19/20; G02B 27/0172; G06T 2219/2004

(57) ABSTRACT

An information processing apparatus (1) according to an aspect of an embodiment includes a drawing unit (6b), a setting unit (6c), and an expansion unit (6e). The drawing unit (6b) draws a virtual object displayed on a display device (4). The setting unit (6c) sets a shielding object indicating the shape of a real object existing in a real space and to be superimposed on the real object. The expansion unit (6e) expands the shielding object toward the virtual object side when a shielding condition indicating that the virtual object drawn by the drawing unit (6b) is partially shielded by the shielding object set by the setting unit is satisfied.

### FIELD

The present invention relates to an information processing apparatus, an information processing method, and an information processing program.

### BACKGROUND

In recent years, a technology for providing a user with augmented reality (augmented reality) for superimposing and displaying a virtual object on a display has become widespread. In such augmented reality, a shielding (occlusion) region representing a shape is set for a real object existing in a real space.

For example, Patent Literature 1 discloses a technique of setting a shielding region for a hand of a user existing in a real space and switching a virtual object shielded in the shielding region to non-display, thereby allowing the user to appropriately grasp a positional relationship between the hand and the virtual object (see, for example, Patent Literature 1).

### CITATION LIST

### Patent Literature

Patent Literature 1: WO 2019/031015 A

### SUMMARY

### Technical Problem

However, in the related art, a superimposition shift of the shielding region with respect to the real object is not taken into consideration, and there is a case where a user feels uncomfortable due to the superimposition shift of the shielding region.

The present invention has been made in view of the above, and an object of the present invention is to provide an information processing apparatus, an information processing method, and an information processing program capable of reducing discomfort caused by a superimposition shift of a shielding region.

### Solution to Problem

To solve the above-mentioned problems and achieve the purpose, an information processing apparatus according to an aspect of an embodiment includes a drawing unit, a setting unit, and an expansion unit. The drawing unit draws a virtual object displayed on a display device. The setting unit sets a shielding object indicating the shape of a real object existing in a real space and to be superimposed on the real object. The expansion unit expands the shielding object toward the virtual object side when a shielding condition indicating that the virtual object drawn by the drawing unit is partially shielded by the shielding object set by the setting unit is satisfied.

### Advantageous Effects of Invention

According to one aspect of the embodiment, it is possible to reduce the discomfort caused by the superimposition shift of the shielding region.

### BRIEF DESCRIPTION OF DRAWINGS

FIG. 1 is a diagram illustrating an outline of an information processing apparatus according to an embodiment.

FIG. 2 is a diagram illustrating an outline of the information processing apparatus according to the embodiment.

FIG. 3 is a block diagram of the information processing apparatus according to the embodiment.

FIG. 4 is a diagram illustrating an example of processing by a determination unit according to the embodiment.

FIG. 5 is a diagram illustrating an example of processing by the determination unit according to the embodiment.

FIG. 6 is a diagram illustrating an example of processing by an expansion unit according to the embodiment.

FIG. 7 is a graph illustrating an example of processing by the expansion unit according to the embodiment.

FIG. 8 is a diagram illustrating an example of processing by the expansion unit according to the embodiment.

FIG. 9 is a diagram illustrating an example of a display image according to the embodiment.

FIG. 10 is a flowchart illustrating a processing procedure executed by the information processing apparatus according to the embodiment.

FIG. 11 is a flowchart illustrating a processing procedure executed by the information processing apparatus according to the embodiment.

FIG. 12 is a graph illustrating an example of a relationship between a movement distance of a self-position and an expansion degree.

FIG. 13 is a diagram illustrating an example of an expanded object for each user.

FIG. 14 is a hardware configuration diagram illustrating an example of a computer that implements functions of the information processing apparatus.

### DESCRIPTION OF EMBODIMENTS

Hereinafter, embodiments of the present disclosure will be described in detail with reference to the drawings. Note that in each of the following embodiments, the same parts are denoted by the same reference numerals, and redundant description will be omitted.

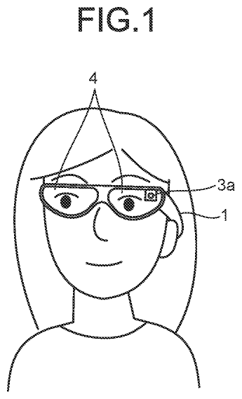

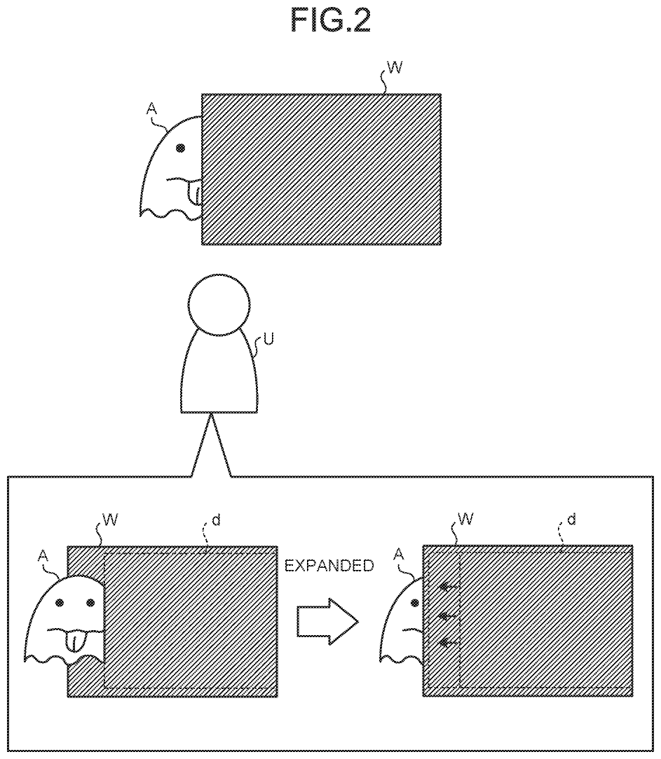

First, an outline of an information processing apparatus according to an embodiment will be described with reference to FIGS. 1 and 2. FIGS. 1 and 2 are diagrams illustrating an outline of the information processing apparatus.

In the example illustrated in FIG. 1, an information processing apparatus 1 is an AR device that provides an augmented reality (AR) and a head mounted display (HMD).

The information processing apparatus 1 is a so-called optical see-through type HMD that includes an optically transparent display unit 4 and displays a virtual object existing in a virtual space on the display unit 4. The information processing apparatus 1 controls the arrangement, shape, and the like of the virtual object based on information of the real space obtained by imaging by an outward camera 3a, for example, information of the position and shape of an object existing in the real space.

Specifically, the information processing apparatus 1 recognizes various objects (hereinafter, referred to as a real object) such as a wall existing in the real space, and sets a shielding object for the real object. The shielding object is three-dimensional data (mesh data) for hiding a virtual object existing behind in the virtual space, and is also referred to as an occlusion region or a collider.

By not displaying the virtual object shielded by the shielding object, the information processing apparatus 1 can allow the user to easily grasp the anteroposterior relationship between the real object and the virtual object corresponding to the shielding object.

By the way, for example, when the information of the real space cannot be correctly recognized, there may be a case where a position where the shielding object is superimposed with respect to the real object is shifted, that is, a so-called superimposition shift occurs. For example, as illustrated in FIG. 2, a scene is assumed in which a virtual object A is displayed behind a wall W that is a real object when viewed from a user U.

For example, when a superimposition shift of a shielding object d corresponding to the wall W occurs with respect to the wall W, a shift occurs in the shielding region that shields the virtual object A by the shielding object d. At this time, there may be a case where the virtual object A that is supposed to exist behind the wall W as viewed from the user U is displayed as if existing in front of the wall W.

Therefore, in this case, it is difficult for the user U to grasp the anteroposterior relationship between the virtual object A and the wall W, and the user U feels uncomfortable. On the other hand, in the information processing apparatus 1 according to the embodiment, in a case where the virtual object A satisfies a shielding condition indicating that the virtual object A is partially shielded by the shielding object d, the shielding object d is expanded to the virtual object A side.

Here, the shielding condition indicates that the virtual object A existing on the back side as viewed from the user U is partially shielded by the shielding object d existing on the front side of the virtual object A. In other words, the shielding condition indicates that the virtual object A existing behind the shielding object d is displayed across the boundary of the shielding object d.

As described above, the information processing apparatus 1 according to the embodiment can appropriately express the positional relationship between the virtual object A and the wall W by expanding the shielding object d and reducing the display region of the virtual object A.

Therefore, according to the information processing apparatus 1 according to the embodiment, it is possible to reduce the discomfort caused by the superimposition shift of the shielding object d.

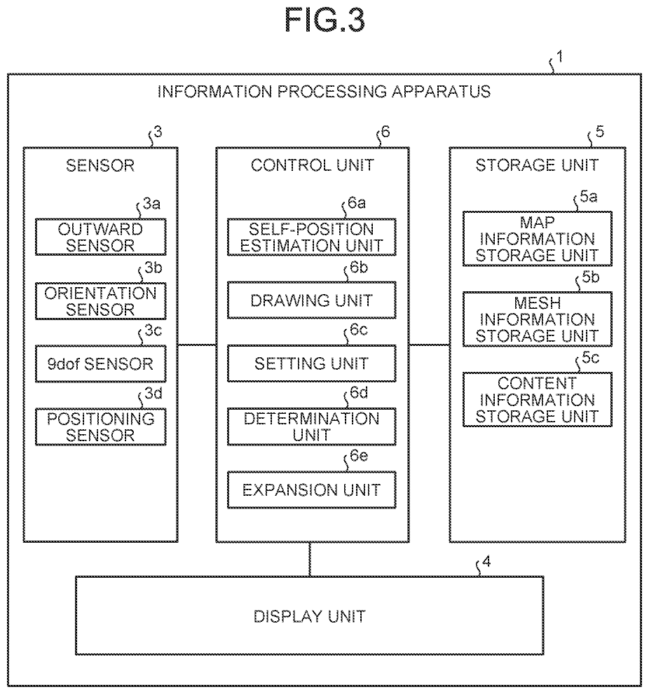

Next, a configuration example of the information processing apparatus 1 according to the embodiment will be described with reference to FIG. 3. FIG. 3 is a block diagram of the information processing apparatus 1 according to the embodiment. In the example illustrated in FIG. 3, the information processing apparatus 1 includes a sensor 3, the display unit 4, a storage unit 5, and a control unit 6.

The sensor 3 includes the outward camera 3a, an orientation sensor 3b, a 9dof (degrees of freedom) sensor 3c, and a positioning sensor 3d. Note that the configuration of the sensor 3 illustrated in FIG. 3 is an example, and is not particularly limited to the configuration illustrated in FIG. 3. For example, in addition to each unit illustrated in FIG. 3, various sensors such as an environmental sensor such as an illuminance sensor and a temperature sensor, an ultrasonic sensor, and an infrared sensor may be included, and each sensor may be one or two or more.

The outward camera 3a is a so-called red green blue (RGB) camera, and captures a video around the user in the real space. It is desirable that the angle of view and the direction of the outward camera 3a be set so as to capture an image of the direction of the user's face in the real space when the outward camera 3a is worn. In addition, a plurality of the outward cameras 3a may be provided. Furthermore, each outward camera 3a may include a depth sensor.

In addition, the outward camera 3a includes, for example, a lens system, a drive system, a solid-state imaging element array, and the like. The lens system includes an imaging lens, a diaphragm, a zoom lens, a focus lens, and the like. The drive system causes the lens system to perform a focusing operation and a zooming operation. The solid-state imaging element array photoelectrically converts imaging light obtained by the lens system to generate an imaging signal. The solid-state imaging element array can be implemented by, for example, a charge coupled device (CCD) or a complementary metal oxide semiconductor (CMOS). The orientation sensor 3b is a sensor that detects the orientation of the display unit 4, and is realized by a geomagnetic sensor.

The 9dof sensor 3c acquires information for estimating a relative self-position and posture of the user (information processing apparatus 1). The 9dof sensor 3c is an inertial measurement device with nine degrees of freedom, and includes a three-axis acceleration sensor, a three-axis gyro sensor, and a three-axis geomagnetic sensor. The 9dof sensor 3c detects an acceleration acting on the user (information processing apparatus 1), an angular velocity (rotation speed) acting on the user (information processing apparatus 1), and an absolute orientation of the user (information processing apparatus 1). The positioning sensor 3d is, for example, a sensor that measures the current position of the information processing apparatus 1 using a global positioning system (GPS).

The display unit 4 has a display surface constituted by, for example, a half mirror or a transmissive light guide plate. The display unit 4 causes the user to view a video by projecting the video (light) from the inside of the display surface toward the eyeballs of the user. Note that the display unit 4 may be a display device such as a smartphone.

The storage unit 5 stores programs and data used to implement various functions of the information processing apparatus 1. The storage unit 5 is realized by, for example, a semiconductor memory element such as a random access memory (RAM) or a flash memory, or a storage device such as a hard disk or an optical disk. The storage unit 5 is also used as a parameter used in various processes, a work area for various processes, and the like.

In the example illustrated in FIG. 3, the storage unit 5 includes a map information storage unit 5a, a mesh information storage unit 5b, and a content information storage unit 5c. The map information storage unit 5a is a storage area that stores map information (so-called environmental map) indicating the surrounding environment in the real space.

The mesh information storage unit 5b is a storage area that stores the above-described shielding object. Note that the shielding object stored in the mesh information storage unit 5b is 3D mesh data indicating the shape of the real object stored in the map information storage unit 5a.

The content information storage unit 5c is a storage area that stores various contents related to the virtual object. Note that various types of information stored in the map information storage unit 5a, the mesh information storage unit 5b, and the content information storage unit 5c may be stored in the server. In this case, the information processing apparatus 1 may appropriately download data from the server via a communication unit (not illustrated).

The control unit 6 controls various processes executed in the information processing apparatus 1. The control unit 6 is realized by, for example, a central processing unit (CPU), a micro processing unit (MPU), or the like executing various programs stored in a storage device inside the information processing apparatus 1 using a RAM as a work area. In addition, the control unit 6 is realized by, for example, an integrated circuit such as an application specific integrated circuit (ASIC) or a field programmable gate array (FPGA). Moreover, in the example illustrated in FIG. 3, the control unit 6 includes a self-position estimation unit 6a, a drawing unit 6b, a setting unit 6c, a determination unit 6d, and an expansion unit 6e.

The self-position estimation unit 6a estimates the self-position of the user (information processing apparatus 1). For example, the self-position estimation unit 6a creates an environmental map and estimates the self-position using a simultaneous localization and mapping (SLAM) method based on the video captured by the outward camera 3a.

For example, the self-position estimation unit 6a estimates the position and orientation of the display unit 4, and calculates a line-of-sight vector indicating the line-of-sight direction of the user based on the estimated position and orientation of the display unit 4. The environmental map created by the self-position estimation unit 6a is stored in the map information storage unit 5a as map information. In addition, information regarding the user's line-of-sight vector estimated by the self-position estimation unit 6a is notified to the drawing unit 6b, the setting unit 6c, and the like as needed.

Note that the self-position estimation unit 6a may create an environmental map and estimate the self-position using a visual inertial odemetry (VIO) method based on the measurement results of the orientation sensor 3b and the 9dof sensor 3c in addition to the captured image captured by the outward camera 3a.

Furthermore, in the real space for which the environmental map has already been created, the self-position estimation unit 6a can also correct the self-position by extracting feature points from the captured image captured by the outward camera 3a and collating the extracted feature points with the feature points of the environmental map stored in the map information storage unit 5a. At this time, the self-position estimation unit 6a may correct the self-position based on the positioning result (global coordinates) by the positioning sensor 3d.

The drawing unit 6b draws a virtual object existing in the virtual space displayed on the display unit 4. For example, the drawing unit 6b draws a virtual object in the user's current field of view based on the estimation result by the self-position estimation unit 6a.

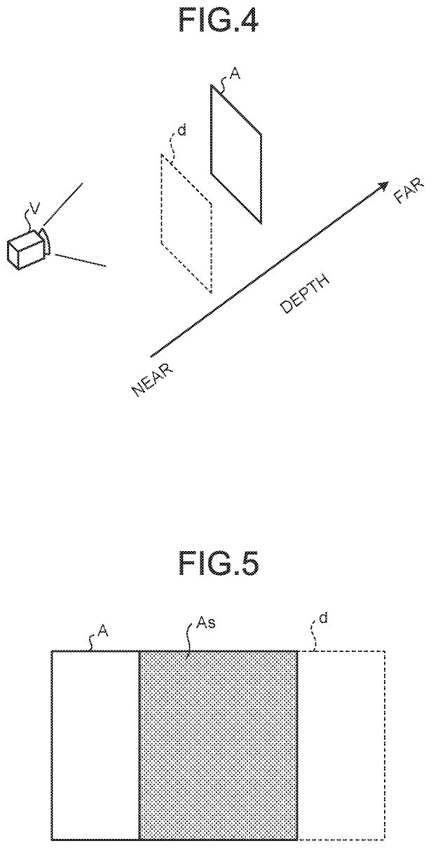

At this time, the drawing unit 6b draws a virtual object using the 3D content stored in the content information storage unit 5c as a 2D image according to the current viewpoint of the user. That is, the drawing unit 6b performs rendering from the 3D content to the 2D image. The virtual object drawn by the drawing unit 6b is stored in a Z buffer (not illustrated) in association with coordinate information in the virtual space including depth information. Note that the Z buffer is an example of a buffer, and is a memory area that stores depth information of each object including the virtual object A and the shielding object d. An example of the Z buffer will be described later with reference to FIG. 4.

The setting unit 6c sets a shielding object indicating a shape of a real object existing in the real space and to be superimposed on the real object. Specifically, first, the setting unit 6c refers to the map information storage unit 5a, and extracts a real object existing within the current display range of the display unit 4 based on the estimation result by the self-position estimation unit 6a. That is, the setting unit 6c extracts a real object that falls within the user's current field of view.

Subsequently, for the extracted real object, the setting unit 6c selects a shielding object in the shape of the real object from the mesh information storage unit 5b, and sets the selected shielding object for the real object. At this time, the setting unit 6c renders the 3D shielding object into 2D similarly to the drawing unit 6b, and then sets the shielding object for the real object.

Similarly to the virtual object drawn by the drawing unit 6b, the shielding object set by the setting unit 6c is stored in the Z buffer in association with coordinate information including depth information. Note that the shielding object may be created at the time of creating the environmental map, or may be dynamically generated by the setting unit 6c for each setting of the shielding object.

The determination unit 6d determines whether or not the shielding condition, which indicates that the virtual object drawn by the drawing unit 6b is partially shielded by the shielding object set by the setting unit 6c, is satisfied.

FIG. 4 and FIG. 5 are diagrams illustrating an example of processing by the determination unit 6d. FIGS. 4 and 5 are diagrams illustrating an example of the processing by the determination unit 6d according to the embodiment. FIG. 4 schematically illustrates the Z buffer.

As illustrated in FIG. 4, the virtual object A and the shielding object d are arranged at corresponding positions (depths) on the Z buffer. The example of FIG. 4 illustrates a case where the shielding object d is arranged on the nearer side than the virtual object A as viewed from a current viewpoint position V of the user. Note that the viewpoint position V indicates the position of the display unit 4, and the direction of the viewpoint position V indicates the direction of the display unit 4.

Therefore, in this case, the virtual object A may be shielded by the shielding object d. Accordingly, the determination unit 6d calculates the angle of view when the virtual object A is viewed from the viewpoint position V.

For example, as illustrated in FIG. 5, at the calculated angle of view, there is a shielding area As in which a part of the virtual object A is shielded by the shielding object d, and the virtual object A and the shielding object d overlap with each other. Therefore, in this case, the determination unit 6d determines that the above-described shielding condition is satisfied.

The determination unit 6d determines that the shielding condition is not satisfied when the virtual object A is on the near side of the shielding object d, or when the virtual object A is on the far side of the shielding object d, but the shielding area As is not present. Note that the determination unit 6d may also determine that the above-described shielding condition is satisfied when the entire virtual object A is shielded by the shielding object, that is, when the entire virtual object A is the shielding area As.

Returning to the description of FIG. 3, the expansion unit 6e will be described. When the determination unit 6d determines that the shielding condition is satisfied, the expansion unit 6e expands the shielding object d that shields the virtual object A.

Then, after setting the final shielding object d, the expansion unit 6e outputs the virtual object A stored in the Z buffer to the display unit 4. As a result, the virtual object A is displayed on the display unit 4. In addition, when the shielding object d is no longer satisfied after the shielding object d is expanded, the expansion unit 6e cancels the expansion of the shielding object d.

That is, the shielding object d is expanded only while the shielding condition is satisfied. In this manner, by temporarily expanding the shielding object d, it is possible to reduce an erroneous operation on the real object when the shielding object d functions as a collider for collision determination for receiving an operation on the real object.

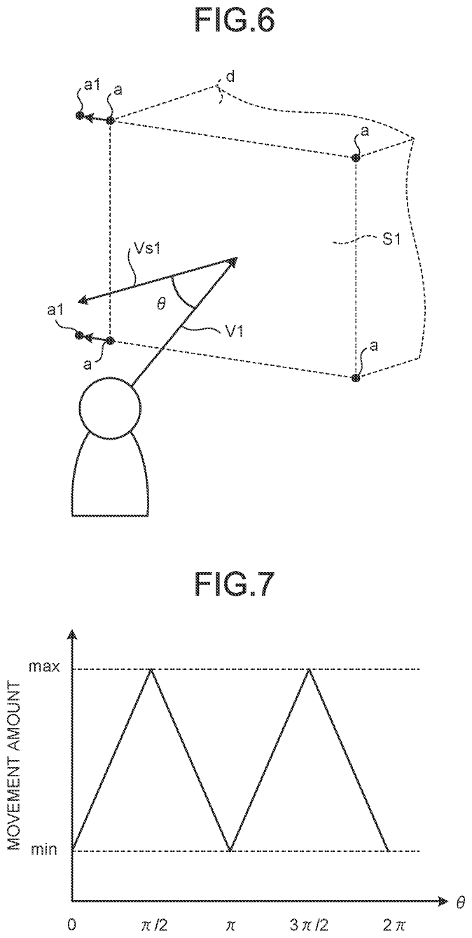

Here, an example of processing by the expansion unit 6e will be described with reference to FIGS. 6 to 8. FIGS. 6 to 8 are diagrams illustrating an example of the processing by the expansion unit 6e according to the embodiment. For example, as illustrated in FIG. 6, the expansion unit 6e expands the shielding object d in consideration of the orientations of faces of the shielding object d. In other words, the expansion unit 6e determines the expansion degree of the shielding object d for each face constituting the shielding object d. Specifically, the expansion unit 6e calculates an angle θ formed by a line-of-sight vector V1 indicating the current position and orientation of the user, and the normal vector of a face constituting the shielding object d.

The example of FIG. 6 illustrates a case where the formed angle θ is an angle formed by a normal vector Vs1 of a face S1 and the line-of-sight vector V1. The expansion unit 6e determines a movement amount for extending each vertex a of the face S1 based on the formed angle θ. The movement amount corresponds to an example of the expansion degree.

For example, as illustrated in FIG. 7, the expansion unit 6e determines the movement amount of each vertex a of the face S1 based on a movement amount set in advance for the calculated formed angle θ. In the example illustrated in FIG. 7, the movement amount is minimized when the angle θ is 0, π, and 2π, and the movement amount is maximized when the formed angle θ is π/2 and 3π/2.

That is, in the example of FIG. 7, the closer the normal vector Vs1 and the line-of-sight vector V1 are to be parallel, the smaller the movement amount, and the closer the normal vector Vs1 and the line-of-sight vector V1 are to be orthogonal, the larger the movement amount.

In addition, the example of FIG. 7 illustrates a case where the movement amount increases linearly when the formed angles θ is between 0 and π/2, and π and 3π/2, and the movement amount decreases linearly between π/2 and π, and 3π/2 and 2π.

Then, after obtaining the movement amount corresponding to the formed angle θ, the expansion unit 6e expands the shielding object d by moving each vertex a illustrated in FIG. 6 to a vertex a1 on the Z buffer. In this manner, the expansion unit 6e expands the shielding object d in the same plane of the Z buffer in order to move each vertex a on the Z buffer.

In other words, the expansion unit 6e does not expand the shielding object d in the depth direction but expands the shielding object d in the width direction facing the depth direction as viewed from the viewpoint position V (see FIG. 6). Note that the relationship between the formed angle θ and the movement amount illustrated in FIG. 7 is an example, and the present invention is not limited thereto.

For example, points (θ) that take the maximum value and the minimum value of the movement amount illustrated in FIG. 7 may be appropriately changed for each content. In addition, it is not necessary to linearly interpolate between the maximum value and the minimum value of the movement amount as illustrated in FIG. 7, and interpolation may be performed non-linearly.

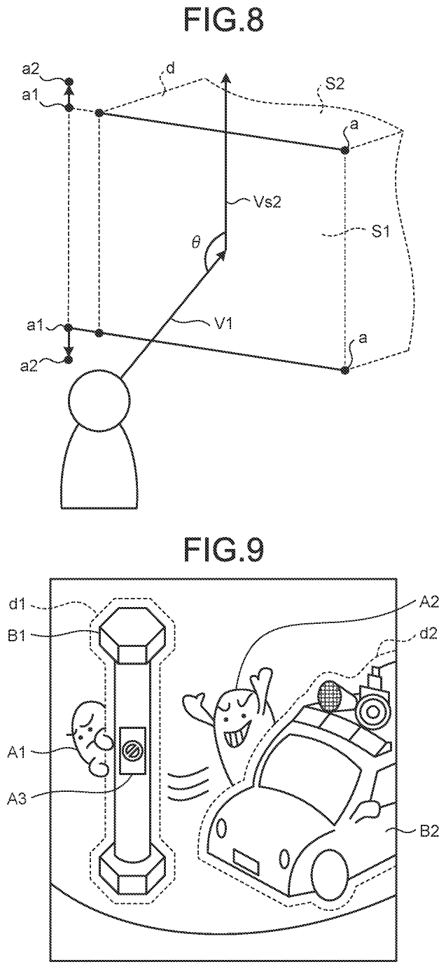

When the movement of the vertex a based on the normal vector Vs1 of the face S1 is completed, the expansion unit 6e further moves the vertex a1 based on the normal vectors of other faces. For example, as illustrated in FIG. 8, the expansion unit 6e calculates the formed angle θ between a normal vector Vs2 of a face S2 and the line-of-sight vector V1 for the face S2 as a target following the face S1, and expands the shielding object d toward the face S2 side by moving the vertex from the vertex a1 to a vertex a2.

The expansion unit 6e finally determines a region in which the shielding object d is expanded by performing the above-described processing on each face constituting the shielding object d. The expansion unit 6e executes the processing for each shielding object d that satisfies the shielding condition.

Then, the expansion unit 6e outputs, to the display unit 4, the shielding object and the virtual object A stored on the Z buffer after the expansion of the shielding object. As a result, the virtual object A having a larger shielded portion by the amount of expansion of the shielding object d is displayed on the display unit 4.

In this manner, in a case where the above-described shielding condition is satisfied, the expansion unit 6e can reduce the discomfort caused by the superimposition shift of the shielding object d by expanding the shielding object d in consideration of the orientation of the user. Note that the expansion unit 6e does not need to expand all faces of the shielding object d, and may expand a boundary region between the shielding object d and the virtual object A. Here, the expanded region indicates a face of the shielding object d in contact with the virtual object A in the state of being displayed on the display unit 4.

Next, an example of a display image displayed on the display unit 4 will be described with reference to FIG. 9. FIG. 9 is a diagram illustrating an example of a display image according to the embodiment. In the example illustrated in FIG. 9, virtual objects A1 to A3 are illustrated, and shielding objects d1 and d2 that are not actually displayed on the display unit 4 are also illustrated.

In the example of FIG. 9, the virtual object A1 is partially shielded by a real object B1 that is a utility pole, and the virtual object A2 is partially shielded by a real object that is a car. Therefore, the virtual object A1 and the virtual object A2, and the shielding object d1 and the shielding object d2 corresponding to the real object B1 and the real object B2, respectively, satisfy the above-described shielding condition.

Therefore, the shielding object d1 and the shielding object d2 are expanded from the actual real object B1 and the real object B2, respectively. In addition, the virtual object A3 arranged in the real object B1 is located closer to the user than the real object B1.

Therefore, since the virtual object A3 and the shielding object d1 corresponding to the real object B1 do not satisfy the above-described shielding condition, the shielding object d1 is not expanded to the virtual object A3 side (that is, the front side). As a result, it is possible to prevent the virtual object A3 located on the front side of the shielding object d1 from being shielded by the shielding object d1.

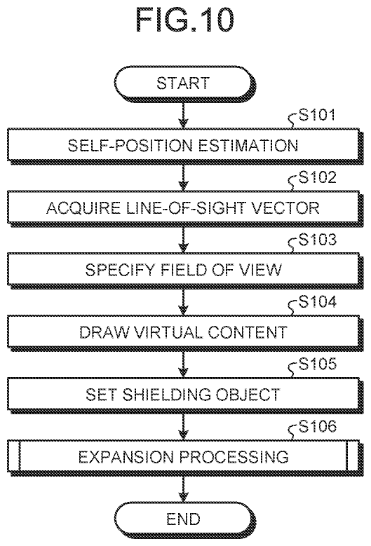

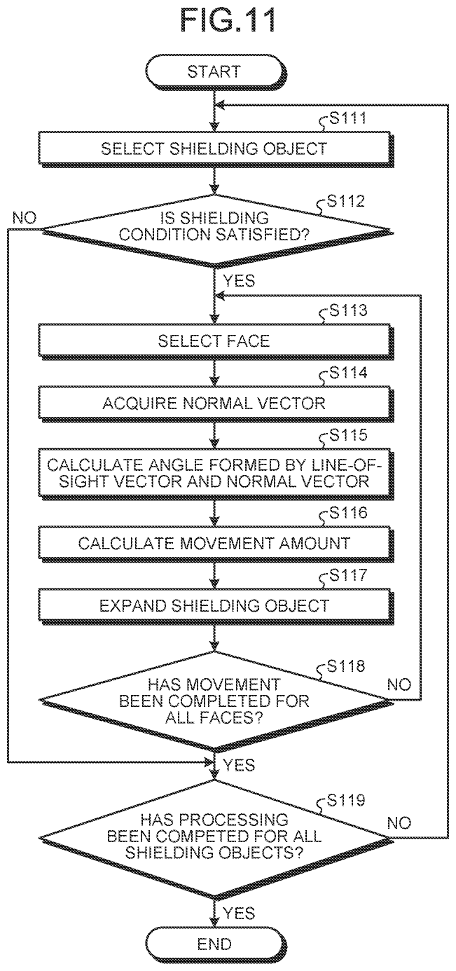

Next, a processing procedure executed by the information processing apparatus 1 according to the embodiment will be described with reference to FIGS. 10 and 11. FIGS. 10 and 11 are flowcharts illustrating a processing procedure executed by the information processing apparatus 1 according to the embodiment. Note that the following processing procedure is repeatedly executed by the control unit 6.

As illustrated in FIG. 10, when performing self-position estimation (step S101), the information processing apparatus 1 according to the embodiment acquires a line-of-sight vector V1 based on the result of the self-position estimation (step S102).

Subsequently, the information processing apparatus 1 according to the embodiment specifies the current field of view of the user based on the self-position and the line-of-sight vector V1 (step S103). Subsequently, the information processing apparatus 1 draws a virtual content (step S104), and sets a shielding object for the real object (step S105).

Thereafter, the information processing apparatus 1 performs expansion processing on the shielding object based on the results up to step S105 (step S106), and ends the processing.

Next, the expansion processing in step S106 illustrated in FIG. 10 will be described in detail with reference to FIG. 11. As illustrated in FIG. 11, the information processing apparatus 1 selects an arbitrary shielding object stored in the Z buffer (step S111), and determines whether or not the selected shielding object satisfies the shielding condition (step S112).

Subsequently, when it is determined that the shielding condition is satisfied (Step S112, Yes), the information processing apparatus 1 selects a face of the shielding object (step S113), and acquires a normal vector of the selected face (step S114).

Subsequently, the information processing apparatus 1 calculates the angle θ formed by the line-of-sight vector of the user and the normal vector (step S115), and calculates the movement amount of each vertex based on the calculated formed angle θ (step S116).

Subsequently, the information processing apparatus 1 expands the shielding object by moving the vertex based on the calculated movement amount (step S117), and determines whether or not the movement of the vertex has been completed for all faces of the shielding object (step S118).

When it is determined in the determination of step S118 that the processing has been completed for all the faces (step S118, Yes), the information processing apparatus 1 determines whether or not the processing has been completed for all the shielding objects (step S119).

When it is determined in the determination of step S119 that the processing has been completed for all the shielding objects (step S119, Yes), the information processing apparatus 1 ends the processing. When it is determined that the processing has not been completed for all the shielding objects (step S119, No), the information processing apparatus 1 proceeds to the processing of step 111.

In addition, when it is determined in step S112 that the shielding object does not satisfy the shielding condition (step S112, No), the information processing apparatus 1 proceeds to the processing in step S119. When it is determined in step S118 that the processing has not been completed for all the faces (step S118, No), the information processing apparatus 1 proceeds to the processing in step S113.

Meanwhile, in the above-described embodiment, a case where the shielding object is expanded based on the formed angle θ has been described, but the present invention is not limited thereto. For example, the shielding object may be expanded based on the estimation result and the estimation accuracy of the self-position estimation unit 6a.

Specifically, in the estimation result of the self-position by the self-position estimation unit 6a, an error is accumulated as the user moves. Therefore, the self-position estimation unit 6a periodically corrects the self-position using, for example, an AR marker or the like.

Accordingly, when the self-position changes from the correction of the self-position to the next correction of the self-position, the error increases in the self-position by the amount of the change. Then, as the error included in the self-position increases, the estimation accuracy of the self-position decreases, so that the superimposition shift of the shielding object with respect to the real object easily occurs. Therefore, the expansion unit 6e may expand the shielding object based on the change amount of the self-position after correcting the self-position.

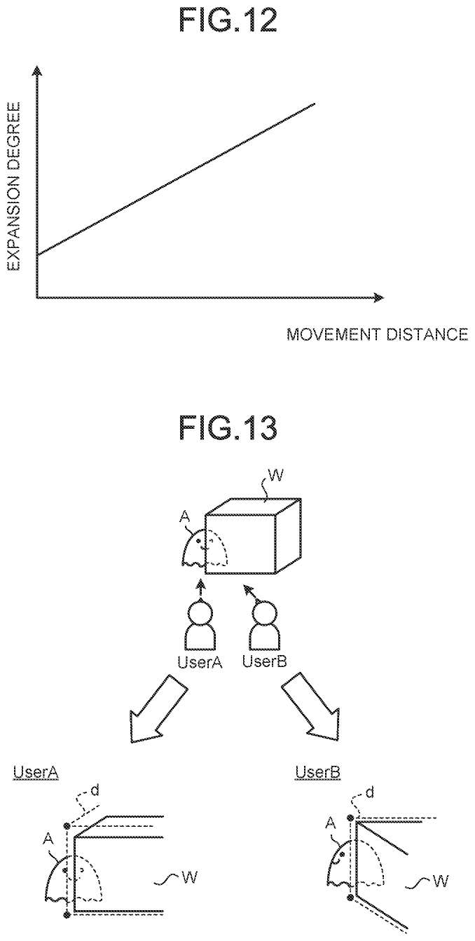

A specific example of this point will be described with reference to FIG. 12. FIG. 12 is a graph illustrating an example of a relationship between a self-position and an expansion degree. Note that the change amount of a self-position is a concept including a movement distance and a rotation angle, but the movement distance will be described below as an example. The expansion degree on the vertical axis illustrated in FIG. 12 indicates the degree of expansion of the shielding object, and the movement distance on the horizontal axis indicates the movement distance of the self-position after the self-position estimation unit 6a corrects the self-position.

In the example illustrated in FIG. 12, the expansion degree increases as the movement distance increases. Therefore, the expansion unit 6e expands the shielding object more greatly as the movement distance increases.

In addition, since the movement distance is reset when the self-position estimation unit 6a corrects the self-position, the expansion unit 6e may return the expansion degree of the shielding object d to the initial value at the reset stage.

Moreover, the present invention is not limited to the above example, and the expansion degree of the shielding object d may be determined based on the feature point obtained from the captured image. This is because it is assumed that the recognition accuracy of each real object existing in the real space is likely to increase as the number of feature points obtained from the captured image increases.

Therefore, since the actual position of a real object can be more accurately grasped as the recognition accuracy increases, it is assumed that the superimposition shift of the shielding object d is less likely to occur. Therefore, the expansion unit 6e may reduce the expansion degree of the shielding object d as the recognition accuracy of the real object increases.

In addition, for example, the expansion degree of the shielding object d may be determined based on various errors included in the sensor 3. For example, an error component included in the detection result of the orientation sensor 3b or the 9dof sensor 3c may be derived in advance, and the expansion degree may be determined based on the error component.

Next, an example in which a plurality of users views the same content will be described with reference to FIG. 13. As illustrated in FIG. 13, for example, it is assumed that a user A and a user B view, from different positions, the virtual object A partially hidden in the wall W that is a real object.

At this time, each of the information processing apparatus 1 of the user A and the information processing apparatus 1 of the user B expands the shielding object d set for the wall W. As a result, as illustrated in the lower diagram of FIG. 13, for example, since the angle (the above-described formed angle θ) with the wall W is different between the user A and the user B, the virtual object A is displayed after the expansion degree of the shielding object is set for each of the information processing apparatus 1 of the user A and the information processing apparatus 1 of the user B.

In this manner, by expanding the shielding object d in each of the individual information processing apparatuses 1, it is possible to reduce the discomfort caused by the superimposition shift of the shielding object d in each of the information processing apparatuses 1.

In addition, in the above-described embodiment, the case of expanding the shielding object d has been described, but the present invention is not limited thereto, and the shielding object d may be entirely slid toward the virtual object A.

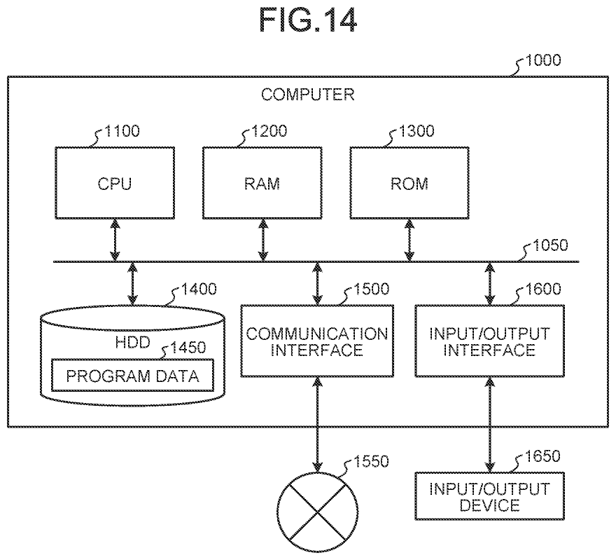

An information device such as the information processing apparatus according to each embodiment described above is realized by a computer 1000 having a configuration as illustrated in FIG. 14, for example. Hereinafter, the information processing apparatus 1 will be described as an example. FIG. 14 is a hardware configuration diagram illustrating an example of the computer 1000 that implements functions of the information processing apparatus 1. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 to the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Moreover, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the information processing apparatus 1, the CPU 1100 of the computer 1000 executes the information processing program loaded on the RAM 1200 to implement the functions of the self-position estimation unit 6a and the like. In addition, the HDD 1400 stores an information processing program according to the present disclosure, data in the map information storage unit 5a, and the like. Note that the CPU 1100 reads the program data 1450 from the HDD 1400 and executes the program data, but as another example, these programs may be acquired from another device via the external network 1550.

Note that the present technique can also have the following configurations.

(1)

An information processing apparatus comprising:

a drawing unit that draws a virtual object displayed on a display device;

a setting unit that sets a shielding object indicating a shape of a real object existing in a real space and to be superimposed on the real object; and

an expansion unit that expands the shielding object toward a side of the virtual object when a shielding condition indicating that the virtual object drawn by the drawing unit is partially shielded by the shielding object set by the setting unit is satisfied.

(2)

The information processing apparatus according to (1), wherein

the expansion unit

cancels expansion of the shielding object when the shielding condition is no longer satisfied after the shielding object is expanded.

(3)

The information processing apparatus according to (1) or (2), wherein

the drawing unit

draws the virtual object that is two-dimensional based on a three-dimensional content, and stores the virtual object on a buffer, and

the expansion unit

expands the shielding object on the buffer.

(4)

The information processing apparatus according to (3), wherein

the setting unit

sets the two-dimensional shielding object with respect to the real object, and

the expansion unit

expands the shielding object in a same plane on the buffer.

(5)

The information processing apparatus according to any one of (1) to (4), wherein

the expansion unit

expands a boundary region between the shielding object and the virtual object.

(6)

The information processing apparatus according to any one of (1) to (5), further comprising:

a self-position estimation unit that estimates a self-position of the display device, wherein

the setting unit

sets the shielding object for the real object included in a display range of the display device based on an estimation result of the self-position estimation unit.

(7)

The information processing apparatus according to (6), wherein

the expansion unit

determines an expansion degree that is a degree of expanding the shielding object for each face constituting the shielding object.

(8)

The information processing apparatus according to (7), wherein

the expansion unit

determines the expansion degree based on an angle formed by a line-of-sight vector indicating a position and an orientation of the display device and a normal vector indicating a normal line of the face.

(9)

The information processing apparatus according to (8), wherein

the expansion unit

expands, according to the expansion degree for each of the faces of the shielding object, the shielding object by moving each vertex of the face.

(10)

The information processing apparatus according to (9), wherein

the expansion unit

reduces the expansion degree as the formed angle is closer to parallel, and increases the expansion degree as the formed angle is closer to orthogonal.

(11)

The information processing apparatus according to any one of (6) to (10), wherein

the expansion degree is determined based on estimation accuracy of the self-position estimation unit.

(12)

The information processing apparatus according to (11), wherein

the self-position estimation unit

corrects the self-position at a predetermined period, and

the expansion unit

determines the expansion degree based on a change amount in the self-position after correction.

(13)

The information processing apparatus according to any one of (1) to (12), wherein

the display device

is a head-mounted display including an optically transparent display unit.

(14)

An information processing method comprising:

by a computer,

drawing a virtual object displayed on a display device;

setting a shielding object indicating a shape of a real object existing in a real space and to be superimposed on the real object; and

expanding the shielding object toward a side of the virtual object when a shielding condition indicating that the drawn virtual object is partially shielded by the set shielding object is satisfied.

(15)

An information processing program causing

a computer to function as:

a drawing unit that draws a virtual object displayed on a display device;

a setting unit that sets a shielding object indicating a shape of a real object existing in a real space and to be superimposed on the real object; and

an expansion unit that expands the shielding object toward a side of the virtual object when a shielding condition indicating that the virtual object drawn by the drawing unit is partially shielded by the shielding object set by the setting unit is satisfied.

### REFERENCE SIGNS LIST

1 INFORMATION PROCESSING APPARATUS
3 SENSOR
3a OUTWARD CAMERA (EXAMPLE OF IMAGING DEVICE)
3b ORIENTATION SENSOR
3c 9dof SENSOR
3d POSITIONING SENSOR
4 DISPLAY UNIT (EXAMPLE OF DISPLAY DEVICE)
5 STORAGE UNIT
5a MAP INFORMATION STORAGE UNIT
5b MESH INFORMATION STORAGE UNIT
5c CONTENT INFORMATION STORAGE UNIT
6 CONTROL UNIT
6a SELF-POSITION ESTIMATION UNIT
6b DRAWING UNIT
6c SETTING UNIT
6d DETERMINATION UNIT
6e EXPANSION UNIT
A VIRTUAL OBJECT
d SHIELDING OBJECT

1. An information processing apparatus comprising:
a drawing unit that draws a virtual object displayed on a display device;
a setting unit that sets a shielding object indicating a shape of a real object existing in a real space and to be superimposed on the real object; and
an expansion unit that expands the shielding object toward a side of the virtual object when a shielding condition indicating that the virtual object drawn by the drawing unit is partially shielded by the shielding object set by the setting unit is satisfied.

2. The information processing apparatus according to claim 1, wherein
the expansion unit
cancels expansion of the shielding object when the shielding condition is no longer satisfied after the shielding object is expanded.

3. The information processing apparatus according to claim 1, wherein
the drawing unit
draws the virtual object that is two-dimensional based on a three-dimensional content, and stores the virtual object on a buffer, and
the expansion unit
expands the shielding object on the buffer.

4. The information processing apparatus according to claim 3, wherein
the setting unit
sets the two-dimensional shielding object with respect to the real object, and
the expansion unit
expands the shielding object in a same plane on the buffer.

5. The information processing apparatus according to claim 1, wherein
the expansion unit
expands a boundary region between the shielding object and the virtual object.

6. The information processing apparatus according to claim 1, further comprising:
a self-position estimation unit that estimates a self-position of the display device, wherein
the setting unit
sets the shielding object for the real object included in a display range of the display device based on an estimation result of the self-position estimation unit.

7. The information processing apparatus according to claim 6, wherein
the expansion unit
determines an expansion degree that is a degree of expanding the shielding object for each face constituting the shielding object.

8. The information processing apparatus according to claim 7, wherein
the expansion unit
determines the expansion degree based on an angle formed by a line-of-sight vector indicating a position and an orientation of the display device and a normal vector indicating a normal line of the face.

9. The information processing apparatus according to claim 8, wherein
the expansion unit
expands, according to the expansion degree for each of the faces of the shielding object, the shielding object by moving each vertex of the face.

10. The information processing apparatus according to claim 9, wherein
the expansion unit
reduces the expansion degree as the formed angle is closer to parallel, and increases the expansion degree as the formed angle is closer to orthogonal.

11. The information processing apparatus according to claim 7, wherein
the expansion degree is determined based on estimation accuracy of the self-position estimation unit.

12. The information processing apparatus according to claim 11, wherein
the self-position estimation unit
corrects the self-position at a predetermined period, and
the expansion unit
determines the expansion degree based on a change amount in the self-position after correction.

13. The information processing apparatus according to claim 1, wherein
the display device
is a head-mounted display including an optically transparent display unit.

14. An information processing method comprising:
by a computer,
drawing a virtual object displayed on a display device;
setting a shielding object indicating a shape of a real object existing in a real space and to be superimposed on the real object; and
expanding the shielding object toward a side of the virtual object when a shielding condition indicating that the drawn virtual object is partially shielded by the set shielding object is satisfied.

15. An information processing program causing
a computer to function as:
a drawing unit that draws a virtual object displayed on a display device;
a setting unit that sets a shielding object indicating a shape of a real object existing in a real space and to be superimposed on the real object; and
an expansion unit that expands the shielding object toward a side of the virtual object when a shielding condition indicating that the virtual object drawn by the drawing unit is partially shielded by the shielding object set by the setting unit is satisfied.
